(19) United States
(12) Patent Application Publication
(10) Pub. No.: US 2023/0186615 A1
(43) Pub. Date: Jun. 15, 2023

(54) Design and Analysis of 3D Printed Structures using Machine Learning

(71) Applicant: National Technology & Engineering Solutions of Sandia, LLC, Albuquerque, NM (US)

(72) Inventors: Adam W. Cook, Albuquerque, NM (US); Devin John Roach, Albuquerque, NM (US); William Reinholtz, Albuquerque, NM (US); Robert Bernstein, Albuquerque, NM (US)

(21) Appl. No.: 17/548,746

(22) Filed: Dec. 13, 2021

(51) Int. Cl. G06V 10/82; G06V 10/774; G06N 3/12; B29C 64/386

(52) U.S. Cl. CPC G06V 10/82; G06V 10/774; G06N 3/12; B29C 64/386; B33Y 50/00

(57) ABSTRACT

A novel method can determine the mechanical properties of additively manufactured structures using artificial neural network and computer vision models. Using this methodology, simulation times can be dramatically reduced, allowing for the implementation of a genetic algorithm which can determine the optimal AM parameters to achieve a targeted mechanical response.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### STATEMENT REGARDING PRIOR DISCLOSURES BY THE INVENTOR OR A JOINT INVENTOR

The following disclosure is submitted under 35 U.S.C. 102(b)(1)(A): Devin J. Roach, Andrew Rohskopf, Craig M. Hamel, William D. Reinholtz, Robert Bernstein, H, Jerry Qi, and Adam W. Cook, “Utilizing computer vision and artificial intellegence algorithms to predict and design the mechanical compression response of direct ink write 3D printed foam replacement structures,” Additive Manufacturing 41, 101950 (2021). The subject matter of this disclosure was conceived of or invented by the inventors named in this application.

### FIELD OF THE INVENTION

The present invention relates to additive manufacturing and, in particular, to the design and analysis of 3D printed structures using machine learning.

### BACKGROUND OF THE INVENTION

Naturally occurring porous materials, such as wood, bone, and cork, found widespread uses throughout history due to their mechanical robustness despite their light weight. Recently, man-made porous materials, commonly known as foams, became a topic of intensive research with increasing applications in transportation, packaging, insulation, sports equipment, aerospace, and biomedicine. See V. Mimini et al., Holzforschung 73(1), 117 (2019); E. Bliven et al., Accid. Anal. Prev. 124, 58 (2019); J. R. Tumbleston et al., Science 347(6228), 1349 (2015); M. Arunkumar et al., J. Sandw. Struct. 19(1), 26 (2017); S. K. Moon et al., Int. J. Precis. Eng. Manuf.—Green Technol. 1(3), 223 (2014); S. Ghosh et al., Adv. Funct. Mater. 18(13), 1883 (2008); and S. Michna et al., Biomaterials 26(28), 5632 (2005).

Traditional foams, a type of cellular solid, consist of stochastic arrangements of material and voids which lead to their unique properties. See L. J. Gibson and M. F. Ashby, Cellular solids: structure and properties, Cambridge university press (1999); and M. F. Ashby, Philos. Trans. R. Soc. A 364(1838), 15 (2006). Various methodologies have been utilized for preparing foams including phase separation, internal phase emulsion, immersion precipitation, direct templating, and gas foaming. See G. A. Mannella et al., Mater. Lett. 160, 31 (2015); C. C. L. Hwa and D. W. McNeil, Method for leaching a polyurethane foam, U.S. Pat. No. 3,125,541 (1964); W. Li et al., J. Mater. Chem. 22(34), 17445 (2012); M. Sušec et al., Macromol. Rapid Commun. 34(11), 938 (2013); L.-P. Cheng et al., Polymer 40(9), 2395 (1999); C. Wu et al., Int. J. Pharm. 403(1), 162 (2011); Q. Hou et al., Biomaterials 24(11), 1937 (2003); X. Yan et al., Polymer 45(25), 8469 (2004); and A. Salerno et al., J. Mater. Sci. Mater. Med. 20(10), 2043 (2009). Many of these methods rely on multi-step procedures which typically require high temperatures, pressures, or chemical leeching and result in relatively stochastic nucleation of pores. This can be highly disadvantageous for engineers who wish to gain precise control over the density or mechanical properties of foams for specific applications. Some attempts to generate foams with varying pore densities have been made by adjusting gas pressure, particulate size, or temperature. A notable example for generating more direct control over pore size and relative density is the use of sacrificial materials, such as salt or urea prills, which can be leached out after being placed in water baths. See C. Hammetter et al., Modeling the Behavior of Cellular Silicone Pads in the Structure-Continuum Transition, PolyMac 2014, SAND2014-18288PE, Sandia National Lab., Albuquerque, N. Mex. (2014); G. M. Gladysz and K. K. Chawla, Composite Foams, in Encyclopedia of Polymer Science and Technology (2004); and X. Mu et al., Mater. Horiz. 4(3), 442 (2017). These methods, however, are time and process intensive while producing highly ordered foams with precise spatial control and micro-scale features, remains a crucial challenge.

In recent years, additive manufacturing (AM), also known as 3D printing, presented itself as a solution to this problem since complex designs can be rapidly implemented and manufactured with high spatial control without the need for expensive tooling, casting dies, or post-processing. See E. B. Duoss et al., Adv. Funct. Mater. 24(31), 4905 (2014); S. M. Montgomery et al., Curr. Opin. Solid State Mater. Sci. 24(5), 100869 (2020); and C. B. Williams et al., Int. J. Adv. Manufact. Technol. 53(1), 231 (2011). Direct-ink write (DIW) 3D printing, in particular, came under special attention due to its ability to process a wide range of materials including elastomers, ceramics, conductive pastes, hydrogels, and other smart materials. See D. J. Roach et al., Smart Mater. Struct. 27(12), 125011 (2018); D. J. Roach et al., ACS Appl. Mater. Interfaces 11(21), 19514 (2019); X. Kuang et al., ACS Appl. Mater. Interfaces 10(8), 7381 (2018); T. A. Cesarano et al., Recent developments in freeform fabrication of dense ceramics from slurry deposition. in 1997 International Solid Freeform Fabrication Symposium (1996); C. Alain et al., J. Biomed. Mater. Res. 53(5), 525 (2000); B. Y. Ahn et al., J. Vis. Exp. 2011(58), 3189 (2011); M. Quanyi et al., Smart Mater Struct. 26(4), 045008 (2017); Q. Zhang et al., Smart Mater. Struct. 27(3), 035019 (2018); R. A. Barry et al., Adv. Mater. 21(23), 2407 (2009); C. D. Armstrong et al., Adv. Mater. Technol. 6(1), 2000829 (2020); J. A. Lewis, Adv. Funct. Mater. 16(17), 2193 (2006); A. S. Wu et al., Sci. Rep. 7(1), 4664 (2017); C. P. Ambulo et al., ACS Appl. Mater. Interfaces 9(42), 37332 (2017); X. Lu et al., Angew. Chem. Int. Ed. 60(10), 5536 (2020); and X. Kuang et al., Adv. Funct. Mater. 29(2), 1805290 (2019). Due to this wide library of printing materials and precise extrusion process, many efforts have been made to fabricate engineered structures that behave like foams, or foam replacement structures (FRS), using DIW. In 2006, Lewis printed colloidal gels which could span gaps in underlying layers and ultimately produce an FRS with an array of material and voids. See J. A. Lewis, Adv. Funct. Mater. 16(17), 2193 (2006). Since then, more complex cellular solids, have been developed to generate FRS with unique strain-energy absorption capabilities or strength-to-weight ratios. See S. K. Moon et al., Int. J. Precis. Eng. Manuf.—Green Technol. 1(3), 223 (2014); and V. R. Caccese et al., Compos. Struct. 100, 404 (2013). Still, the FRS designs presented in these works are highly experience-dependent, relying on unit cell designs intended for specific applications, demonstrating a need for the investigation of tunable foam design strategies which can solve a variety of realistic mechanical loading scenarios.

Multiple design strategies have been employed to further modify the mechanical response of foams by altering the matrix material or pore design. For example, grayscale 3D printing has been introduced allowing mechanical tunability for foam matrix materials. See X. Kuang et al., Sci. Adv. 5(5), eaav5790 (2019). Karyappa combined DIW and immersion precipitation to fabricate foams which have widely tunable porosity from micro to nano scales. See R. Karyappa et al., Mater. Horiz. 6(9), 1834 (2019). In addition to adjustments in pore dimensions and matrix material, entire foam architectures may also be altered to produce unique mechanical responses. Duoss DIW printed two elastomeric foams with slightly differing configurations, however, each exhibited drastically distinct load responses ultimately suggesting the ability to independently tailor mechanical response of cellular solids via micro-architected designs. See E. B. Duoss et al., Adv. Funct. Mater. 24(31), 4905 (2014). Apart from intuitive design strategies, finite element method (FEM) simulations have been employed to characterize layers of viscoelastic materials and use them to find optimal designs for energy dissipation in packaging and helmet applications. See M. C. Rice et al., J. Mech. Phys. Solids 141, 103966 (2020). Many researchers have also attempted to model porous foams directly, though the viscoelastic models are exceedingly nonlinear while microstructural models for highly complex 3D structures are challenging, especially at large deformations. See N. J. Mills et al., Int. J. Solids Struct. 46(3), 677 (2009); W.-Y. Jang et al., Int. J. Solids Struct. 45(7), 1845 (2008); and S. Gaitanaros et al., Eur. J. Mech. A-Solid 67, 243 (2018). The primary drawback of FEM simulations, however, is that they are computationally expensive such that exploring a large design space, with many architectures or pore sizes, would be very time intensive.

### SUMMARY OF THE INVENTION

The present invention is directed to a method to design and analyze additively manufactured structures, comprising developing a model (for example, an artificial neural network (ANN) model) for the mechanical response of the additively manufacturing structure based on one or more printing parameters. The mechanical response can comprise a compression, tension, or shear response. The additively manufactured structure can comprise a polymer, metal, or ceramic. The method can further comprise finding one of more printing parameters to obtain a desired mechanical response of an additively manufactured structure from the ANN model using a genetic algorithm (GA). The method can further comprise acquiring an image of an additively manufactured structure, analyzing the image (for example, using a computer vision analysis) to determine one or more printing parameters of the additively manufactured structure, and predicting a mechanical response of the additively manufactured structure from the one or more printing parameters determined using the model.

As an example of the invention, an AI-based approach was used to determine the compression behavior of direct-ink write (DIW) printed foam replacement structures (FRS) using simple cross-sectional images. By recording experimental data for a relatively small number of samples, computer vision and ANN algorithms were used to make inferences about an FRS's mechanical compression response. Using this method, engineers can rapidly make predictions about a foam's mechanical properties and their applicability for specific applications without the need for extensive experimentation or computational modelling. Finally, using the ANN for simulation results, a GA was developed which could rapidly (˜60 s) discover the optimal DIW printing parameters to produce FRS for target mechanical compression responses. Therefore, an AI-based framework can predict mechanical response characteristics, enabling a time and computationally efficient method for designing 3D structures for specific engineering applications.

### BRIEF DESCRIPTION OF THE DRAWINGS

The detailed description will refer to the following drawings, wherein like elements are referred to by like numbers.

FIG. 1A is a flow diagram of a method to use computer vision to make predictions about foam mechanical properties from a single cross-sectional image of a 3D printed foam. FIG. 1B is a flow diagram of a method to generate optimal 3D printing parameters to achieve a desired, targeted mechanical response from a DIW printed foam.

FIG. 2 is a schematic illustration of the two methods.

FIGS. 3A-3D illustrate FRS printing parameters and experimental design space. FIG. 3A is a schematic of FRS being DIW printed with the inset highlighting the three primary design parameters that can be adjusted: filament diameter, filament spacing, and number of layers. FIG. 3B is a photograph of a DIW printed FRS. FIG. 3C is a graph depicting the filament diameter and number of layers design space for the 250 printed FRS used in this study. FIG. 3D is a graph showing the filament spacing variable as a function of the printed FRS number with the inset demonstrating that the spacing was changed for each foam in the design space.

FIGS. 4A-4D show compression characteristics of various DIW printed FRSs or foams. FIG. 4A is a graph of compression curves for foams that have varying filament spacings demonstrating a trend from stiff-to-soft with increasing filament spacing. FIG. 4B is a graph of compression curves for FRSs that have varying layer heights demonstrating differing plateau stresses but highly differing plateau lengths. FIG. 4C is a graph of the derivative of the compression curve with roman numerals (I) and (II) indicating the critical points during the compression of a FRS. FIG. 4D shows images of an FRS at each of the points indicated by roman numerals in FIG. 4C indicating when an FRS begins to buckle (I) and densify (II).

FIGS. 5A-5F shows the results of the computer vision algorithm. FIG. 5A shows a sample cross-sectional image fed to a computer vision algorithm which was used to determine the primary FRS printing parameters labeled in the image. FIG. 5B is an image showing circles found using the computer vision algorithm with the blue circles being kept and the red being omitted using an outlier approach. FIG. 5C is a graph of the relative frequency of filament diameter error when using the Canny and Sobel edge finding techniques. FIG. 5D is an image showing lines found using the Hough lines finding technique for determining the number of layers. FIG. 5E is a graph showing a comparison between the number of layers detected by the computer vision algorithm vs. the number of printed layers for the first 100 FRSs. FIG. 5F is a graph showing frequency of error values for the filament spacing as determined by the computer vision algorithm demonstrating a high frequency of zero error.

FIGS. 6A-6D show the results using the artificial neural network (ANN). FIG. 6A is a schematic of the ANN architecture consisting of the three layers used to predict the relationship between the DIW printing parameters and the FRS's mechanical compression curve. FIG. 6B is a graph showing that the neural network can be used to accurately predict the compression data from experiments that were not included in training data. FIG. 6C is a graph showing that the neural network can accurately make inferences about FRSs that are within gaps in the design space. FIG. 6D is a graph showing that by combining the neural network and computer vision algorithms, a FRS's mechanical compression response can be accurately predicted using a cross-sectional image.

FIGS. 7A-7E illustrate using a GA to design foams based on target mechanical properties. FIG. 7A is a graph showing the four mechanical compression parameters input into the GA to construct a target compression response for a foam. FIG. 7B is a flowchart detailing the components of the genetic algorithm used to determine the optimal FRS printing parameters based on target compression parameters. FIG. 7C is a graph of convergence statistics for the GA for three different population sizes. FIG. 7D is a graph of the resulting 3D printing parameters determined by the GA to achieve the target compression curve. FIG. 7E is a graph showing that GA can also determine multiple 3D printing parameter solutions for a single target compression curve.

### DETAILED DESCRIPTION OF THE INVENTION

The present invention provides a novel methodology for approaching both the mechanical analysis and the design of additively manufactured (AM) structures using machine learning (ML) and, in particular, a combination of artificial neural networks (ANNs), computer vision, and genetic algorithms (GAs).

Due to their ease of implementation, rapid pattern recognition, and ability to make complex decisions, ANNs have found widespread use in search engines, financial modelling, marketing, and self-driving vehicles. Recently, ANNs have been applied to classical mechanics problems such as predicting the crack propagation characteristics of metals, torsion in iron alloys, or multi-scale quantum mechanical models. See Y-C. Hsu et al., Matter 3(1), 197 (2020); V. Narayan et al., ISIJ Int. 39(10), 999 (1999); G. C. Y. Peng et al., Arch. Comput. Methods Eng. 28, 1017 (2021); and L. Shen et al., J. Chem. Theory Comput. 12(10), 4934 (2016). Gu utilized ANNs to design fracture resistant composite structures with varying toughness and strength ratios. See G. X. Gu et al., Addit. Manuf. 17, 47 (2017). This approach, however, relies on data gathered from thousands of FEM simulations for 2D architectures, limiting its applicability for directly modeling complex 3D porous micro-structures. Recently, Jordan substituted FEM simulations for a small set of experimental results to train an ANN which could describe the temperature and strain rate dependent mechanical response of polypropylene. See B. Jordan et al., Int. J. Plast. 135 102811 (2020). Here, a relatively small experimental set could be used to train an ANN that accurately represents a complex architectural design space. In creating an ANN model, however, one must provide adequate inputs that describe the situation to be predicted. To increase the usability and convenience of the model, the process of extracting inputs based on simple measurements or calculations should be rapid and automated. In many applications ranging from self-driving vehicles to mechanical property prediction based on material geometry, simple images may contain the information which m be input to the ANN model. The automatic inspection and rapid data acquisition from images for this purpose can be readily achieved using computer vision.

Computer vision has seen rapid advancements in recent years extracting and utilizing critical parameters from images enabling technologies such as self-driving cars, automated health monitoring, and facial recognition. See A. Hetzroni et al., Adv. Space Res. 14(11), 203 (1994); and X. W. Ye et al., J. Sens. 5, 1 (2016). The most common use of computer vision in the field of mechanics is for digital image correlation (DIC) which is used to determine the displacement of a structure as a function of time. See A. Jafari Malekabadi et al., Comput. Electron. Agric. 141, 131 (2017); P. L. Reu and T. J. Miller, J. Strain Anal. Eng. Des. 43(8), 673 (2008); A. K. Landauer et al., Exp. Mech. 58(5), 815 (2018); A. K. Landauer et al., J. Mech. Phys. Solids 133, 103701 (2019); and X. Zhai et al., Int. J. Impact Eng. 129, 112 (2019). These approaches, however, use computer vision to track pattern displacement over large time intervals and therefore require substantial datasets and complex analysis software, rather than the analysis of simple static images. While these studies demonstrate possible applications of using ML in materials design, they were mostly focused on using ML models to predict properties of materials or structures rather than designing new structures with desired properties. To design a foam to have specific mechanical behavior, the design problem must be framed as an optimization problem to find the optimal design parameters.

A GA is a multi-objective optimization technique which mimics the process of natural selection to achieve optimal design solutions based on a desired outcome. Consequently, GAs have demonstrated great promise in rapidly discovering optimized solutions for complex design problems in chemistry, electromagnetics, molecular modelling, composite design, 4D printing, and a variety of other engineering disciplines. See A. Niazi and R. Leardi, J. Chemom. 26(6), 345 (2012); D. S. Weile and E. Michielssen, IEEE Trans. Antennas Propag. 45(3), 343 (1997); A. Rohskopf et al., Npj Comput. Mater. 3(1), 27 (2017); B. Liu et al., Comput. Methods Appl. Mech. Eng. 186(2), 357 (2000); C. M. Hamel et al., Smart Mater. Struct. 28(6), 065005 (2019); S. Wu et al., Adv. Intell. Syst. 2(8), 2000060 (2020); D. A. Coley, An Introduction to Genetic Algorithms for Scientists and Engineers (1999); and M. T. Bhoskar et al., Mater. Today: Proc. 2(4), 2624 (2015). Regarding the mechanics of composites, training an ANN can often become computationally unfeasible due to the large mesh densities and representative volume element (RVE) sizes required to achieve a size converged piece of training data for the GA to utilize. For this reason, researchers have turned to GAs for determining optimal composite designs for critical aerospace components, prosthetics, lattice structures, among other exciting applications. See S. Obayashi, “Multidisciplinary design optimization of aircraft wing planform based on evolutionary algorithms” in SMC'98 Conference Proceedings, 1998 IEEE International Conference on Systems, Man, and Cybernetics (Cat. No. 98CH36218), 1998; M. Cilia et al., PLoS One 12(9), e0183755 (2017); A. Muc and W. Gurba, Compos. Struct. 54(2), 275 (2001); and K. D. Salonitis et al., Int. J. Adv. Manufact. Technol. 90(9), 2689 (2017).

AM of porous polymeric materials, such as foams, recently became a topic of intensive research due their unique combination of low density, impressive mechanical properties, and stress dissipation capabilities. Conventional methods for fabricating foams rely on complex and stochastic processes, making it challenging to achieve precise architectural control of structured porosity. In contrast, AM provides access to a wide range of printable materials, where precise spatial control over structured porosity can be modulated during the fabrication process enabling the production of FRSs. Current approaches for designing FRSs are based on intuitive understanding of their properties or an extensive number of FEM simulations. These approaches, however, are computationally expensive and time consuming.

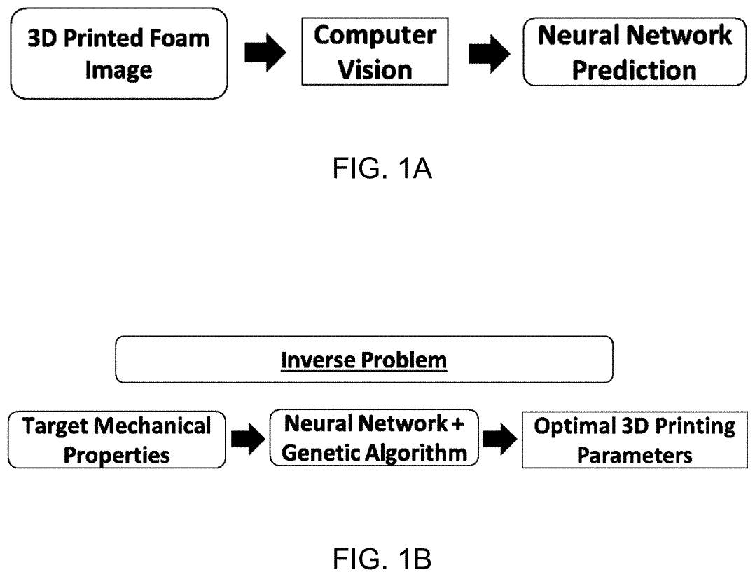

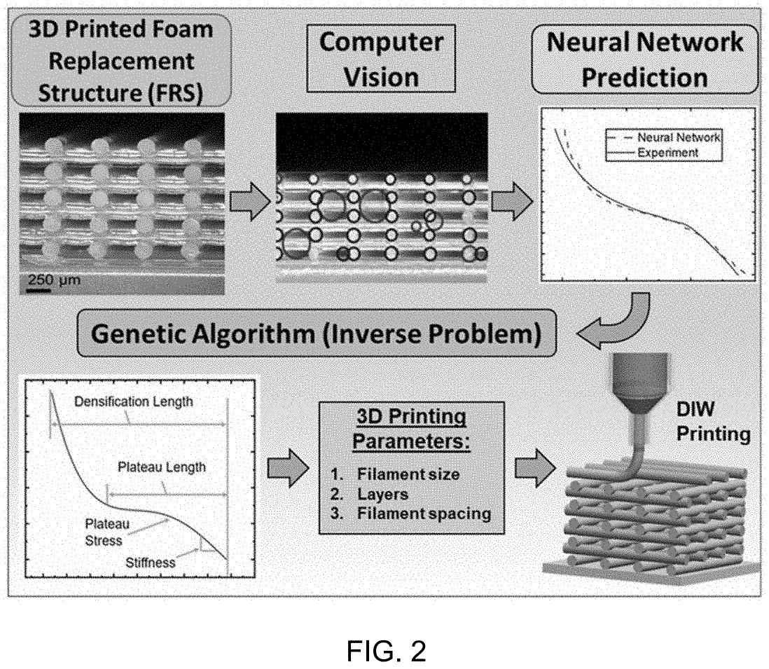

In contrast, the present invention can predict the mechanical response of an additively manufactured FRS foams using a simple cross-sectional image, as shown in FIG. 1A. By obtaining measurement data for a relatively small number of samples, an ANN can be trained, and a computer vision algorithm can be used to make predictions about foam mechanical properties from a single cross-sectional image of a 3D printed foam using the trained ANN. Alternatively, as shown in FIG. 1B, a GA can be used to solve the inverse design problem, generating the optimal 3D printing parameters that an engineer can use to achieve a desired, targeted mechanical response from an additively manufactured FRS foam. A schematic illustration of the two processes is shown in FIG. 2 and described in detail below. The methods described herein provide an avenue for entirely autonomous design and analysis of additively manufactured structures using artificial intelligence.

As an example of the invention, an array of FRSs were DIW printed with various thicknesses, filament spacing, and filament diameters. After compression testing, general trends within the data can be identified as the printing parameters are adjusted; however, capturing the complex relationship between each of the variables is tedious. Therefore, a computer vision algorithm was produced which could determine foam printing parameters from a cross-sectional image of the printed FRS with a small error. An ANN was then implemented that could be trained using the experimental data developed from the DIW-printed FRSs. The ANN was then used to not only accurately predict the compression behavior of a foam using its cross-sectional image but also to infer the compression data of foams for which there is no prior mechanical data. Lastly, a GA was developed which could solve the engineering design problem of finding printing parameters, i.e. ANN inputs, to obtain a desired compression curve. This methodology enables the design of additively manufactured structures that cannot otherwise be obtained by mechanical models due to their complexity, time of implementation, or nonexistence.

### DIW Printing of FRSs

A two-part silicone elastomer, DOWSIL SE 1700, produced by DOW Chemical (Midland, Mich., USA) was used to DIW print an array of FRS. The silicone ink was prepared for printing by homogenizing at a ratio of 10:1 part A:B in a vacuum planetary mixer (Think ARV 310, Thinky Inc., Laguna Hills, Calif., USA) for 60 s at 2000 rpm and 7 kpa. Following mixing, the silicone resin was transferred to 60 mL syringes and centrifuged at 2000 rpm for 3 minutes prior to printing. The rheological properties of SE 1700 and the suitability of its use with DIW printing techniques did not require characterization beyond what has been previously reported. See E. B. Duoss et al., Adv. Funct. Mater. 24(31), 4905 (2014).

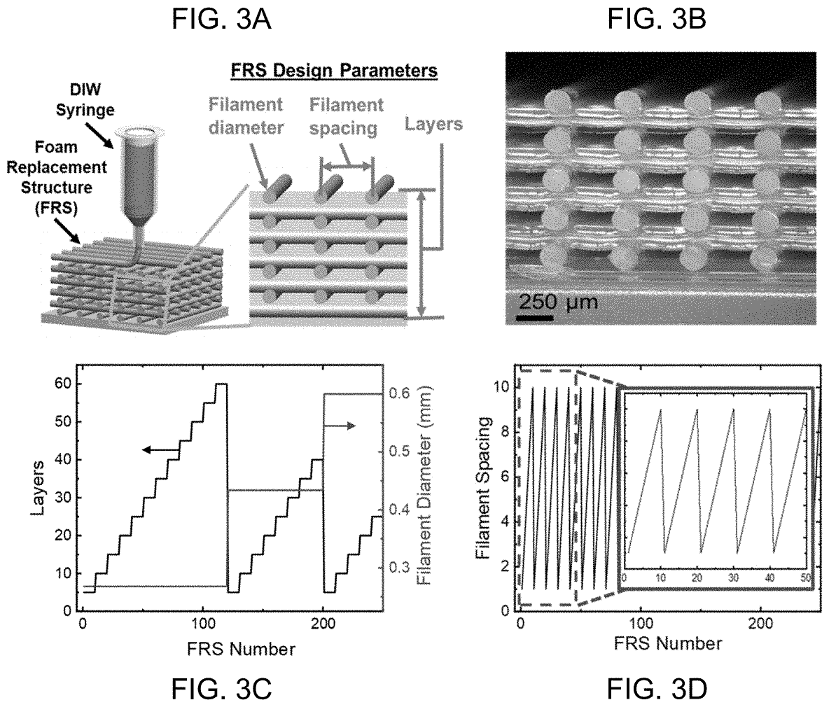

The use of DIW printing provides the advantage of printing complex architectures with precise dimensional accuracy and can therefore be used to print structures that perform like foams. The silicone elastomer was DIW printed on a flat substrate to produce a wide variety of FRSs with simple cubic architectures. A custom engineered DIW printing system having computer-controlled motion stages was used to translate a build platen in the X-Y plane. A schematic of the DIW printing process utilized to produce the FRS is shown in FIG. 3A. A constant displacement syringe pump affixed to the translating motion stage of the Z-axis provided a method of depositing silicone at known volumetric dispense rates. Custom toolpath generation software was used to coordinate the movement of the XYZ motion stages and material extrusion pump to fabricate FRS from predefined toolpaths. The silicone elastomer was printed at room temperature onto aluminum plates pretreated with a PTFE mold release agent. After printing, the FRS was transferred to an oven and cured for 30 minutes at 150° C., followed by 24 hours at 125° C.

The inset of FIG. 3A shows each of the FRS design parameters that were varied, namely the filament diameter, filament spacing, and number of layers. Key design variables and printing conditions of the FRSs are summarized in Table 1. An image of a DIW printed FRS is shown in FIG. 3B. FIGS. 3C and 3D are graphical depictions of the entire design space studied. As seen in FIG. 3C, three different filament diameters (0.25, 041, and 0.584 mm) were used while the number of layers was adjusted linearly, in intervals of five, for each diameter. Finally, FIG. 3D shows that for every layer height, ten filament spacings (1-10) were printed. Varying the DIW design parameters in this manner led to 250 unique printed FRS designs.

TABLE 1
Critical FRS design and printing parameters. For each nozzle size used
to print FRS, the number of printed layers was incremented by 5 layers
up to the maximum number of layers shown. The spacing between filaments
was incremented by integer multiples of the nozzle diameter.

| | | | | Filament | | Number |
|---|---|---|---|---|---|---|
| Nozzle | Extrusion | Layer | Number | Spacing (x's | Printing | of |
| Diameter | Rate | Height | of | nozzle | Speed | unique |
| (mm) | (cm³/min) | (mm) | layers | diameter) | (mm/s) | FRS |
| 0.250 | 0.0972 | 0.2150 | 5-60 | 1-10 | 40 | 120 |
| 0.410 | 0.2543 | 0.3526 | 5-40 | 1-10 | 40 | 80 |
| 0.584 | 0.4701 | 0.5022 | 5-25 | 1-10 | 40 | 50 |

### Compression Testing of DIW Printed FRS

Following AM of the silicone FRSs, their performance was evaluated through analysis of mechanical compression results. To obtain the compression data for the FRSs, a simple compression test was performed using an Instron (Norwood, Mass., USA) 5564 Universal Testing Machine. During testing, samples were centered on the bottom stationary platen (platen size, 6 inches diameter). The indenter or “ram” (moving platen) had a diameter of 1.125 inches. Both platens were made of polished stainless steel. The platens were cleaned and inspected to ensure that they were free of dust or broken particles from previous experiments. The compression rate was 0.2 mm/s. To characterize the mechanical compression response of the FRSs, the nominal stress and compression gap were measured. The nominal stress is defined as the measured force divided by the area of the FRS's 2D footprint. The compression gap is defined as the gap between the two platens. Only the first compression loading cycle was observed, as subsequent compression cycles lead to different mechanical compression responses. See S. K. Reddy et al., RSC Adv. 4(91), 50074 (2014).

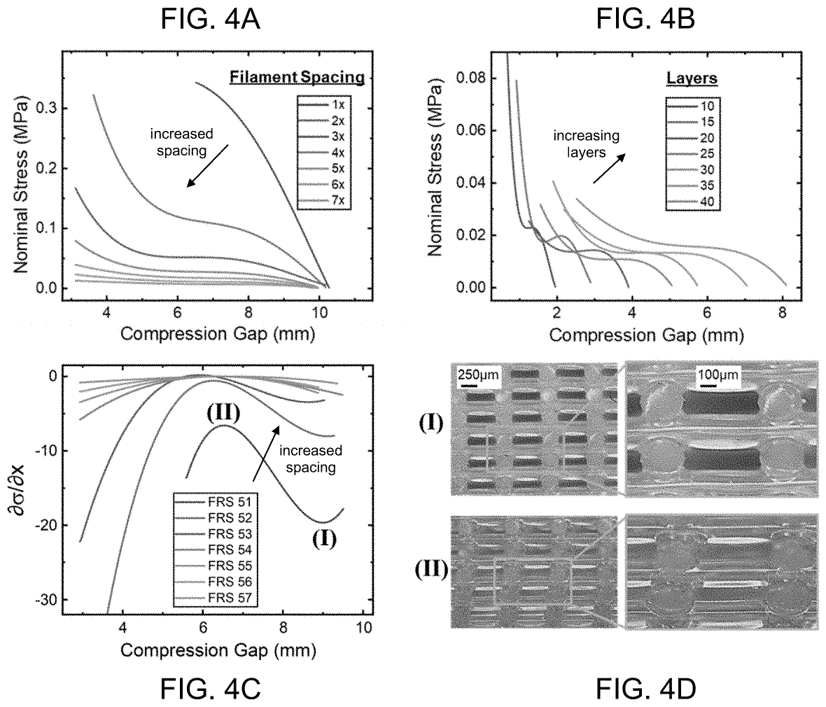

The general trends and results are shown in FIGS. 4A-4D. It is important to note that the nominal stress was observed as a function of the FRS compression gap as it provides a direct mapping of printed FRS performance in 1D compression behavior to end-use applications. FIG. 4A shows the compression results for FRS 91 through FRS 97, which have the same filament diameter and number of layers (0.250 μm and 50, respectively, as shown in FIG. 4C) but have different filament spacings (1 and 7, respectively, as shown in FIG. 4D). This graph demonstrates that by increasing the filament spacing while fixing the other two printing parameters, the FRS trend from stiff to soft. This is consistent with typical foam mechanics where higher relatively density leads to higher stiffness. Alternatively, FIG. 4B shows that by increasing the number of layers, while fixing the filament diameter and spacing (0.250 μm and 5, respectively), the FRSs have similar plateau stresses but differing plateau lengths.

Some interesting observations can be made about the FRS characteristics when a derivative of the nominal stress with respect to the compression gap is plotted. The results for FRS 51 through FRS 57 (0.250 μm filament diameter, 30 layers, spacing of 1 to 7) are plotted in FIG. 2C and two critical points are highlighted with roman numerals. Roman numeral (I) indicates where the foam transitions from its initial, linear-elastic response to the buckling plateau region. In this region, the stress remains relatively constant despite an increased deformation. This is caused by a buckling response of the FRS causing it to become softer. Roman numeral (II) indicates a second change in the slope of the compression curve where the FRS enters densification. This occurs when the pore walls begin to come into contact with each other making the FRS behave like a solid polymer resulting in the FRS becoming asymptotically stiff. A photograph of an FRS at each of these points is shown in FIG. 4D. The relative location of these points can be used as critical design parameters for engineers when deciding how to construct foams for specific applications.

It may be possible to capture the general trend observed in these figures using a complicated power law relationship between the printing parameters and compression results. However, when multiple variables are adjusted, it becomes increasingly complicated to draw relationships with their resulting mechanical compression properties. Therefore, it is imperative to capture the trend using a more complicated model; however, microstructural FEM simulations tend to be computationally expensive, especially for large displacements where elements contact or become inverted. Therefore, an ANN was trained to capture the complex relationship between the printing parameters and resulting mechanical response, as determined by computer vision analysis of FRS images and mechanical compression response of the DIW printed FRSs.

### Computer Vision Analysis of FRS Images

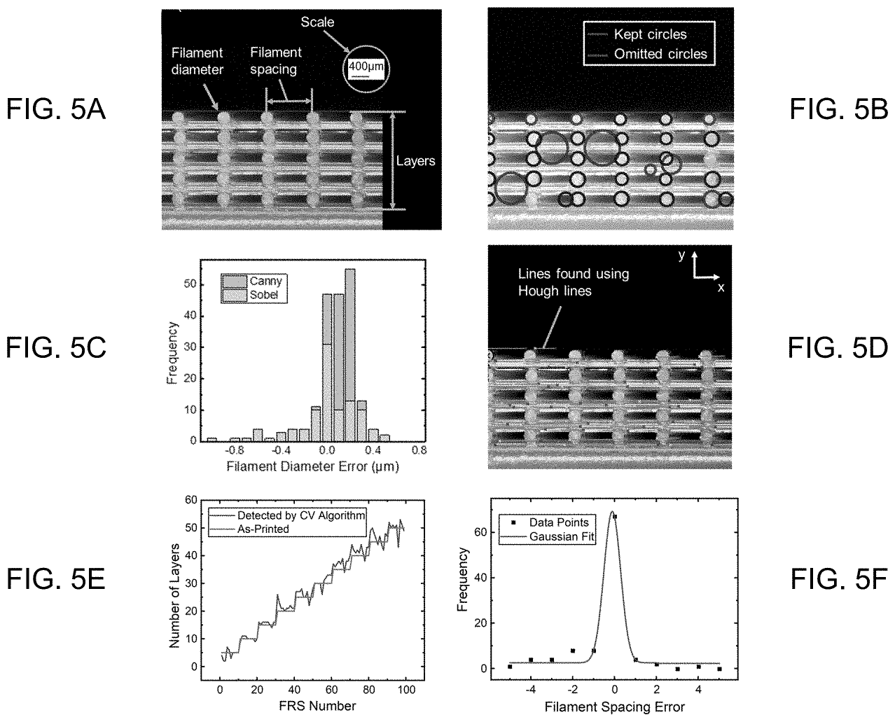

Computer vision tools have seen large advancements in recent years enabling rapid identification of critical features from images. Cross-sectional images of the DIW-printed FRS were taken and a computer vision algorithm was written to determine the filament diameter, filament spacing, and number of layers. FIG. 5A shows a cross-sectional image of a FRS with labels of each of the parameters being mined. The computer vision algorithm used the methods outlined in Petkovic where sigmoidal functions were observed. See D. Petkovic et al., “Verifying The Accuracy Of Machine Vision Algorithms And Systems” in Twenty-Second Asilomar Conference on Signals, Systems and Computers (1988).

To determine the relevant information from the cross-sectional images, novel methods and various pre-built algorithms were combined. To find the filament diameter, the Sobel and Canny edge finding algorithms were implemented. More information on these methods can be found in Sharifi. See M. Sharifi et al., “A classified and comparative study of edge detection algorithms” in Proceedings, International Conference on Information Technology: Coding and Computing (2002). Based on the detected edges, object polarization was used to find the circles as their color differed greatly compared to the surrounding regions. In some cases, additional circles were found by the algorithm and omitted using a 5% outliers filter. FIG. 5B shows an example of the kept and omitted circles highlighted with blue and red, respectively. To validate the algorithm, the resulting accuracy of each edge detection method is depicted graphically in FIG. 5C. Here, the error between the filament diameter detected by the computer vision algorithm and the measured filament diameter were calculated and plotted with their relative frequency. From this data it was determined that the Canny edge finding method determined the filament diameter with a higher accuracy.

To find the number of layers of a FRS, the Canny edge detection method was used, followed by the Hough line finding algorithm. See N. Kiryati et al., Pattern Recognit. 24(4), 303 (1991). FIG. 5D shows the lines detected using this method, as indicated by green lines overlaid on the image. By identifying the top and bottom lines, subtracting the distance between them in the y direction, and dividing by the filament diameter (as determined by the computer vision algorithm), an estimation of the number of layers could be made. FIG. 5E shows that the number of layers found using this method closely matches the number of printed layers. Lastly, the spacing between the filaments was determined by subtracting the distance between centroids of the circles found in FIG. 5B in the x-direction. FIG. 5F shows the error using this approach follows a zero-centered Gaussian curve and therefore is highly accurate.

### ANN Modeling of Mechanical Compression Response of DIW Printed FRS

When engineers design foams, they need to understand how they will act in the context of their desired applications. However, complex architectural geometry, large elastic deformations, rate dependencies, and temperature dependencies make it extremely difficult to precisely model the mechanical compression response of foams. Therefore, a model which can accurately predict foam behaviors for a large design space, using a relatively small experimental set is required. ANNs are a class of machine learning algorithms that can be used to rapidly parameterize a design space. ANNs are comprised of a collection of interconnected nodes, sometimes called neurons. ANNs aggregate neurons into multiple layers which create mathematical relationships between inputs and outputs based on a set of training data. Further information and terminology surrounding ANNs can be found in Hecht-Nielson. See R. Hecht-Nielsen, “III.3—Theory of the Backpropagation Neural Network**Based on “nonindent””, which appeared in Proceedings of the International Joint Conference on Neural Networks 1, 593-611, June 1989. © 1989 IEEE, in Neural Networks for Perception, H. Wechsler, Editor. 1992, Academic Press. p. 65-93. Thereore, an ANN was trained using the mechanical compression results of the printed FRSs described above and was able to successfully parameterize a complex architectural design space for large deformations.

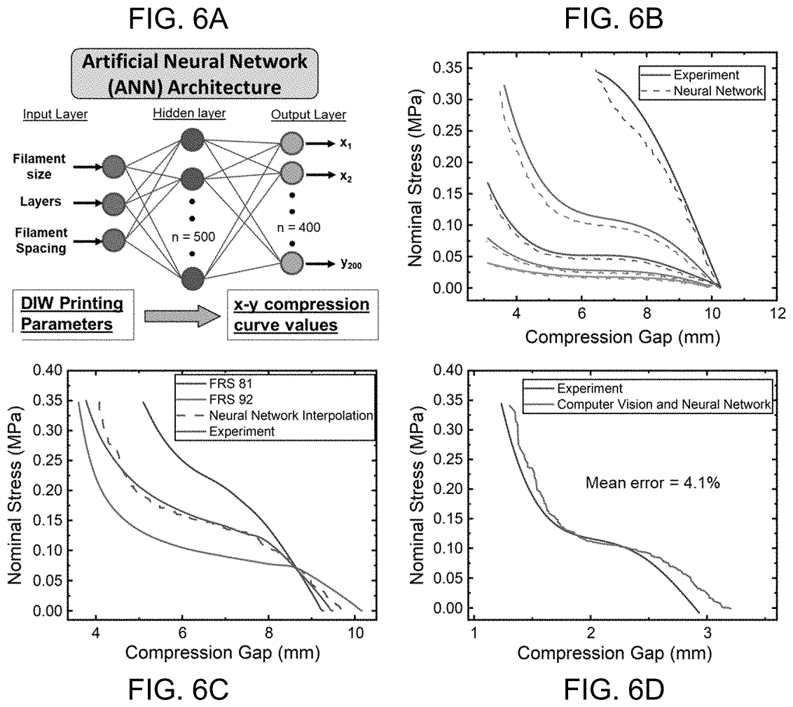

The ANN used in this example is a shallow neural network with an input layer of 3 nodes, a single hidden layer with 500 nodes, and an output layer of 400 nodes as shown schematically in FIG. 6A. The inputs to the ANN are the three printing parameters: filament size (diameter), filament spacing, and number of layers. The outputs are 200× points and 200 y points which form a single compression curve. The ANN was trained using back propagation and a mean square error (MSE) was utilized to rate the error at various epochs, or iterations. The training set was made up of the experimental compression data gathered from the 250 printed FRSs as described above. The data was split into 80% training, 10% validation, and 10% testing data to properly interrogate the accuracy of the ANN. The ANN was determined to be sufficiently trained when the MSE reached a value of 0.1. Training the ANN took 67 seconds in a total of 2870 epochs, or iterations.

The ANN described above can accurately predict the compression response of AM foams given their printing parameters. FIG. 6B shows a comparison between the compression response recording during experiments and the response generated by the ANN for different foams. It is important to note that the compression curves used in FIG. 6B were not used in the training set. In addition to accurately predicting the compression behavior of FRS within the design space of the ANN, the network can also make inferences about FRS within gaps in the design space. FIG. 6C shows the ANN-predicted compression curve for a hypothetical FRS with printing parameters between those of foams FRS 81 (0.250 μm filament diameter, 45 layers, spacing of 1) and 92 (0.250 μm filament diameter, 50 layers, spacing of 2). Here, both the filament spacing and the number of layers were adjusted to design parameters that were not used to train the ANN. The ANN accurately predicted a compression curve for 2.5 filament spacings and 48 layers, demonstrating its ability to make accurate inferences about FRS that are within the design space for which the ANN has no prior data. To validate this prediction, the FRS was printed, and its resulting compression curve, as determined by experiment, demonstrates good agreement with the ANN prediction as seen in FIG. 6C.

Due to the advantages garnered by the computer vision and ANN algorithms, they could be combined to generate mechanical compression data using a simple cross-sectional image of a printed FRS. A demonstrative example is shown in FIG. 6D. Here, the computer vision algorithm determines the DIW printing parameters using a cross-sectional image of FRS 22 (0.250 μm filament diameter, 15 layers, spacing of 2). Then, using these parameters as inputs, the ANN can accurately (within 4.1% mean error) predict the FRS's resulting mechanical compression response. This entire process takes less than a few seconds of computational time.

### Genetic Algorithm for FRS Design

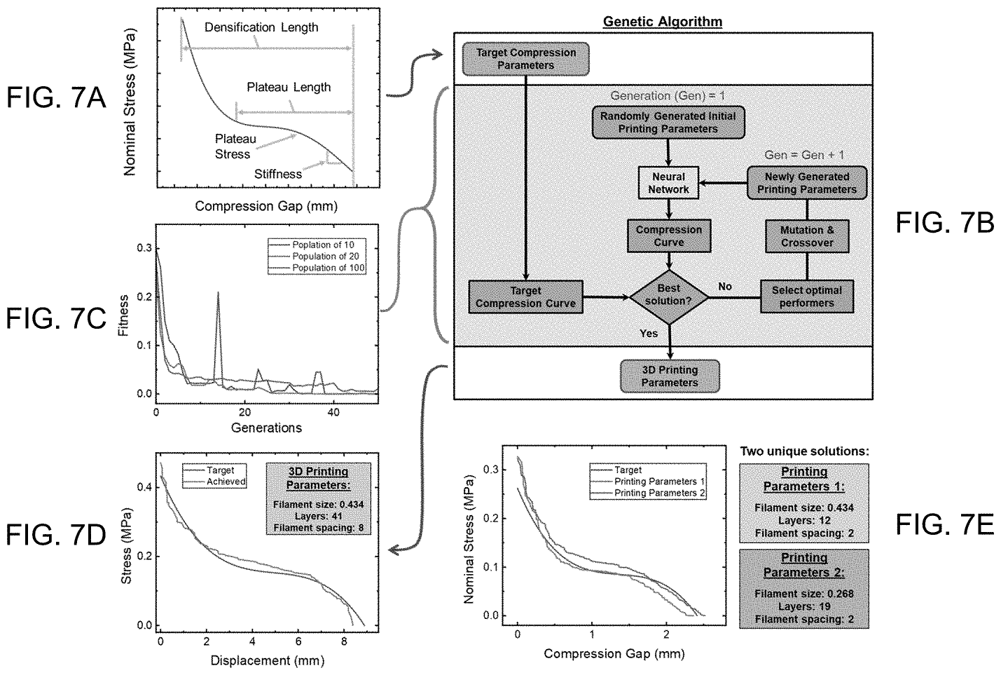

The results outlined above can be used to rapidly model FRSs from a large architectural design space, even up to large deformations. The advantages garnered by this approach allow engineers to rapidly characterize foams, however, searching an extremely large design space for an optimized FRS design based on specific mechanical constraints can remain a challenge. This problem can be solved by employing another AI-based solution, called a genetic algorithm (GA), which can rapidly search the design space to find optimized solutions based on target parameters. FIG. 7A illustrates the four compression parameters that an engineer would use when designing an FRS, namely, stiffness, plateau stress, plateau length, and densification length.

A flow chart detailing the GA-based design process can be seen in FIG. 5B. By inputting the four target compression parameters, the GA can output the FRS printing parameters needed to produce the desired mechanical compression response. The gray section of FIG. 7B represents the GA. First, the target compression parameters are used to generate a target compression curve which can be used as the goal of the GA-optimization algorithm. The GA begins by creating an initial population, or first generation, of randomly generated printing parameters within the design space. Next, the ANN described above generates compression curves based on the first generation of printing parameters. To determine if the generated compression curves match the target compression curve a fitness function is utilized for optimization. The expression used to determine the fitness of the compression curve for the 200 y-values is as follows,

$${ℱ}_{y} = \frac{1}{200} {\sum }_{i = 1}^{200} \sqrt{{( {y}_{i}^{target} - {y}_{i}^{actual} )}^{2}}$$

where yᵢ^{target} is the y point on the target compression curve, yᵢ^{actual} is the y point generated by the ANN. See C. M. Hamel et al., Smart Mater. Struct. 28(6), 065005 (2019). The fitness for the x values, [symbol] ₓ, is also calculated in this way. [symbol] ₓ and [symbol] _{y} are then normalized between 0 and 1 such that an overall fitness function can be expressed as follows,

[symbol]

= [symbol] _{norm,x}+ [symbol] _{norm,y}

Here, the goal is to minimize the error between the target x-y values and the ANN-generated x-y values, which can be expressed as

$${min}_{{xy}^{actual}} ℱ ,$$

for each generation, or iteration of the GA. If an optimized solution is not found the next generation of ANN input parameters is developed by keeping the best solutions from the previous generation and performing mutation and crossover operations to the remainder of the population. More details on how this process works can be found in Coley. See D. A. Coley, An Introduction to Genetic Algorithms for Scientists and Engineers (1999).

To test the viability of the GA for solving a foam design problem, a target compression curve was developed based on four critical foam design parameters. In this example, the densification length, plateau length, plateau stress, and stiffness were set to 9 mm, 6 mm, 0.125 MPa, and 0.4, respectively. FIG. 7C shows the fitness of a population of printing parameters as a function of the generation, or iterations, through the GA. It was observed that 20 individuals in a single population could achieve the best fitness and fastest convergence. The target and achieved compression curves can be seen in FIG. 7D with the inset shows the resulting 3D printing parameters determined by the GA to produce an FRS with the desired compression curve. Lastly, FIG. 7E shows that the GA-based design approach may not always produce unique solutions. Here, two 3D printing parameter design solutions were discovered, greatly increasing a designer's potential for achieving a desired response. These results demonstrate great promise for engineers seeking to design foams with specific mechanical characteristics in both a time and computationally efficient manner.

### CONCLUSION

This invention provides a method for dramatically reducing computational and experimental costs by implementing AI-based approaches in the mechanical characterization and design of AM components. While the example above focuses on the mechanical compression response of an elastomer-based FRS, this method can be extended to include other materials such as metals, ceramics, or other polymers. Furthermore, other mechanical loading scenarios, such as tension or shear, can be observed and used to train the ANN. The primary implications of this invention are described below.

First, the use of computer vision algorithms can provide real-time, vision-based inspection technique for AM components. This approach can be especially well-suited for high production volume AM environments where each printed object cannot be inspected for its mechanical readiness prior to use. This methodology can be extended to include estimations of the mechanical properties of multi-material AM composites where building constitutive models may not be feasible.

Second, ANNs can provide a ready alternative for providing mechanical models when traditional methods such as FEM and continuum mechanical models fall short. For the case of foams, it is very difficult to accurately capture large deformations using FEM models due to element inversions. Therefore, the entire simulation process can be replaced using a trained ANN. Furthermore, to discover new constitutive laws, experimental data and AI can be used to fill gaps in continuum mechanical models. This approach is called a data-continuum hybrid approach. Using this approach, material laws are substituted for constitutive relationships derived from the ANN. As a notable example, Jordan utilized an experimental data set to train a neural network to discover the hardening law for polypropylene up to 60% strain. When combined with existing viscoelastic models, constitutive equations were developed which accurately estimated the polypropylene stress evolution for all strain and temperature histories. See B. Jordan et al., Int. J. Plast. 135 102811 (2020). While constitutive models describing soft material systems remain a challenge, utilizing data-driven and AI-based predictive modeling can provide a ready solution.

Lastly, predictive algorithms, such as ANNs, are extremely applicable for rapidly and efficiently providing data for computationally heavy optimization algorithms, such as GAs, which must explore large parameter spaces. Using traditional simulation techniques, such as FEM, to provide inputs to a GA can be time or computationally prohibitive, requiring multiple hours or even days to find a solution. As an example, by employing an ANN as the de-facto simulation methodology, a large printing parameter design space can be rapidly searched, and an optimal solution can be found in about one minute of computation time.

The present invention has been described as the design and analysis of 3D printed structures using machine learning. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method to design and analyze additively manufactured structures, comprising:
developing a model for a mechanical response of the additively manufacturing structure based on one or more printing parameters.

2. The method of claim 1, wherein the model comprises an artificial neural network model.

3. The method of claim 1, wherein the mechanical response comprises a compression, tension, or shear response.

4. The method of claim 1, wherein the additively manufactured structure comprises a polymer, metal, or ceramic.

5. The method of claim 1, wherein the additively manufacturing structure comprises a direct-ink write (DIW) printed structure.

6. The method of claim 5, wherein the DIW printed structure comprises a foam replacement structure.

7. The method of claim 6, wherein the one or more printing parameters comprise filament diameter, filament spacing, or number of layers of the foam replacement structure.

8. The method of claim 2, wherein the artificial neural network model is trained using experimental mechanical response data from one or more additively manufactured structures.

9. The method of claim 1, further comprising finding the one of more printing parameters that predict a desired mechanical response of an additively manufactured structure from the model.

10. The method of claim 9, wherein the finding uses a genetic algorithm.

11. The method of claim 9, wherein the desired mechanical response comprises a compression response.

12. The method of claim 11, wherein the compression response comprises a stiffness, plateau stress, plateau length, and/or densification length.

13. The method of claim 9, further comprising additively manufacturing a structure using the one or more printing parameters found.

14. The method of claim 1, further comprising:
acquiring an image of an additively manufactured structure,
analyzing the image to determine one or more printing parameters of the additively manufactured structure, and
predicting a mechanical response of the additively manufactured structure from the one or more printing parameters determined using the model.

15. The method of claim 14, wherein the analyzing comprises a computer vision analysis of the image.
